(19) United States
(12) Patent Application Publication
(10) Pub. No.: US 2023/0329214 A1
(43) Pub. Date: Oct. 19, 2023

(54) OUTDOOR VISCOUS TRAP MOSQUITO KILLING LAMP

(71) Applicant: NINGBO DAYANG TECHNOLOGY CO, LTD., Ningbo (CN)

(72) Inventors: Jun Zheng, Ningbo (CN); Yuanai Ning, Ningbo (CN)

(21) Appl. No.: 18/119,282

(22) Filed: Mar. 9, 2023

(30) Foreign Application Priority Data
Apr. 15, 2022 (CN) 202220877434.X

(51) Int. Cl. A01M 1/14

(52) U.S. Cl. CPC A01M 1/145; A01M 2200/012

(57) ABSTRACT

The disclosure discloses an outdoor viscous trap mosquito killing lamp including a lamp body, wherein the outdoor viscous trap mosquito killing lamp further includes a frame and a base, the lamp body is positioned above the base, the frame is connected between the lamp body and the base; a light emitting assembly of the lamp body extends into the frame; a trapping plate is arranged on the base and is positioned within the frame, the trapping plate is positioned below the light emitting assembly; an area between the light emitting assembly and the trapping plate serves as a trapping area. The outdoor mosquito eradication lamp is both safe and environmentally friendly and is convenient to be cleaned up.

### CROSS REFERENCE TO RELATED APPLICATIONS

The present disclosure claims priority of Chinese Utility Model Application No. 202220877434.X, filed on Apr. 15, 2022, the entire contents of which are hereby incorporated by reference.

### TECHNICAL FIELD

The disclosure relates to the technical field of mosquito killing lamp, and more particularly to an outdoor viscous trap mosquito killing lamp.

### DESCRIPTION OF THE PRIOR ART

Mosquito killing lamps are mosquito killing tools developed based on mosquitoes’ behaviors, such as phototaxis, moving with air flow, sensitive to temperature, gregariousness, especially the behavior of chasing carbon dioxide wind and sex pheromone. The mosquito killing lamps can be divided into electronic mosquito killing lamps, viscous mosquito killing lamps, negative pressure airflow mosquito catching lamps. The mosquito killing lamps are a relatively environmentally friendly way to kill mosquitoes, have characteristics of simple construction, cheap sale, aesthetically pleasing, small volume, power consumption, and the like. However, the structure of the existing mosquito lamps is simple, and the efficiency of killing mosquitoes is not high, which are not conducive to the killing of mosquitoes, therefore, the use of mosquito lamp is not convenient and effective. Furthermore, the existing mosquito killing lamps attract mosquitoes through a mosquito killing lamp, and then kill mosquitoes via potion or electric shock. The potion has some off-taste or toxicity, causes some discomfort, especially brings great damage to a baby’s body. For the method of killing mosquitoes via electric shock, a pungent smell is produced after the mosquito is shocked, which is not environmentally friendly or safe, and the mosquito killing lamp is not convenient to be cleaned up.

### SUMMARY OF THE DISCLOSURE

The technical problem to be solved by the present disclosure is to provide an outdoor viscous trap mosquito killing lamp, the outdoor mosquito eradication lamp is both safe and environmentally friendly and is convenient to be cleaned up.

A technical solution of the present disclosure is to provide an outdoor viscous trap mosquito killing lamp including a lamp body, the outdoor viscous trap mosquito killing lamp further includes a frame and a base, the lamp body is positioned above the base, the frame is connected between the lamp body and the base; a light emitting assembly of the lamp body extends into the frame; a trapping plate is arranged on the base and is positioned within the frame, the trapping plate is positioned below the light emitting assembly; an area between the light emitting assembly and the trapping plate serves as a trapping area.

Compared to the prior art, the outdoor viscous trap mosquito killing lamp having the above structure of the present disclosure, has the following advantages that:

Since outdoor viscous trap mosquito killing lamp further includes the trapping plate, the trapping plate is used to kill the mosquitoes, which is safe and environment friendly and is convenient to be cleaned up. The trapping plate is positioned below the light emitting assembly, and the area between the light emitting assembly and the trapping plate serves as a trapping area, which result in a better trapping effect.

As a development, the trapping plate is detachably connected to an upper surface of the base and a viscous sticker is attached to an upper surface of the trapping plate. With such a configuration, the trapping plate is easier to be disassembled and has a reasonable position.

As a development, a limiting protruding ring is provided on a sidewall of the base, a lower end of the frame is mounted around an upper end of the base and a lower end surface of the frame abuts against the limiting protruding ring. With such a configuration, the frame and the base have simple mounting structure and are easy to be assembled.

As a development, a protrusion is provided on a sidewall of the upper end of the base, an inner wall of the lower end of the frame is provided with a groove, the protrusion is engaged in the groove. With such a configuration, the protrusion and the groove are used to prevent the frame from escaping from the base, resulting in a more reliable connection.

As a development, the frame is provided with connecting rods, a connecting ring and a supporting ring; a number of the connecting rods is at least two, a lower end of each connecting rod is connected to the connecting ring, an upper end of each connecting rod is connected to the lamp body, and the supporting ring is arranged on an outer side of the connecting rods and connected to the connecting rods; the connecting ring is mounted around the upper end of the base. Such a configuration leads to a simple structure, a convenient production and an aesthetic appearance.

As a development, the lamp body further includes a control box, a control board is arranged within the control box; the light emitting assembly includes a light emitting module and a lamp cover, the light emitting module is connected to the control box and the lamp cover covers the light emitting module, and the light emitting assembly is electrically connected to the control board. Such a configuration is simple and convenient to be assembled.

As a development, a supporting member is connected to a bottom plate of the control box; the light emitting module includes a lighting lamp set disposed on a sidewall of the supporting member and a mosquito attracting lamp set disposed on a lower end of the supporting member; light emitted by the lighting lamp set transmits from a side portion of the outdoor viscous trap mosquito killing lamp; and light emitted by the mosquito attracting lamp set transmits to the trapping plate. With such a configuration, the light emitted by the lighting lamp set transmits from the side portion of the outdoor viscous trap mosquito killing lamp, which presents a better lighting effect; the light emitted by the mosquito attracting lamp set transmits to the trapping plate, which may attract mosquitoes and insects to the trapping area, thereby improving the trapping effect.

As a development, the supporting member includes a mounting ring and a hollow supporting column, an upper end of the supporting column is connected to the mounting ring, the mounting ring is fixedly connected to the bottom plate of the control box, an inner cavity of the supporting column is in communication with an inner cavity of the control box; the lighting lamp set is sleeve-shaped and is disposed around the supporting column; the mosquito attracting lamp set is flat-shaped and is connected to a lower end of the supporting column, and the mosquito attracting lamp set covers an opening at the lower end of the supporting column and limits the lighting lamp set. Such a configuration is simple and is convenient to be assembled.

As a development, a cylindrical light cover surrounds the lighting lamp set and is semitransparent, the cylindrical light cover is arranged within the lamp cover. With such a configuration, the cylindrical light cover surrounds the lighting lamp set, a color of the cylindrical light cover may be selected as desired to provide good decorative effect.

As a development, an inner cavity of the supporting column serves as a battery housing, a battery is arranged within the battery housing; a limiting post is arranged on an inner wall of the supporting column, the limiting post abuts against a lower side of the battery, the limiting post is configured to limit a position of the battery; the battery is electrically connected to the control board. Such a configuration has a more compact structure and a rational design.

As a development, a solar panel is arranged on an upper surface of the control box, the solar panel is electrically connected to the control board. With such a configuration, the solar panel may charge the battery, which is environmentally friendly.

As a development, a supporting bar is connected to the base and a lower end of the supporting bar is provided with a pointed cone. With such a configuration, the outdoor mosquito killing lamp can be conveniently inserted into the lawn through the supporting bar.

### BRIEF DESCRIPTION OF DRAWINGS

FIG. 1 is a schematic perspective view of the outdoor viscous trap mosquito killing lamp of the present disclosure.

FIG. 2 is a schematic exploded view of the outdoor viscous trap mosquito killing lamp of the present disclosure.

FIG. 3 is a partial schematic exploded view of the outdoor viscous trap mosquito killing lamp of the present disclosure.

FIG. 4 is a schematic perspective view of the frame being separated of the outdoor viscous trap mosquito killing lamp of the present disclosure.

FIG. 5 is a schematic exploded view of the lamp body of the outdoor viscous trap mosquito killing lamp of the present disclosure.

FIG. 6 is a partial schematic exploded view of the lamp body of the outdoor viscous trap mosquito killing lamp of the present disclosure.

FIG. 7 is a schematic perspective view of the supporting member of the outdoor viscous trap mosquito killing lamp of the present disclosure.

FIG. 8 is a block diagram of the control board of the outdoor viscous trap mosquito killing lamp of the present disclosure.

The reference numbers shown in the figures are: 1 lamp body, 101 case body, 102 case cover, 103 control board, 104 charging interface, 105 switch, 106 lamp cover, 107 cylindrical light cover, 108 lighting lamp set, 109 mosquito attracting lamp set, 110 jack, 2 frame, 201 connecting rod, 202 connecting ring, 203 supporting ring, 204 groove, 3 base, 301 slot, 302 limiting protruding ring, 303 protrusion, 4 supporting member, 401 mounting ring, 402 supporting column, 403 insert, 404 battery housing, 405 limiting post, 406 opening, 5 battery, 6 solar panel, 7 trapping plate, 701 viscous sticker, 8 trapping area, 9 supporting bar, 901 pointed cone, 10 control box.

### DDESCRIPTION OF EMBODIMENTS

For a better understanding of the present disclosure, various aspects of the present disclosure will be explained in more detail with reference to the accompanying drawings. It is to be understood that these detailed descriptions are only illustrative of exemplary embodiments of the present disclosure and are not intended to limit the scope of the present disclosure in any way. The reference numerals refer to the same elements throughout the description.

In the drawings, the thickness, size, and shape of objects have been slightly enlarged for ease of illustration. The drawings are merely examples and are not drawn strictly to scale.

It will be further understood that the terms “includes,” “including,” “having,” “includes,” and/or “including,” when used in this specification, specify the presence of stated features, integers, steps, operations, elements, and/or components, but do not exclude the presence or addition of one or more other features, integers, steps, operations, elements, components, and/or combination thereof.

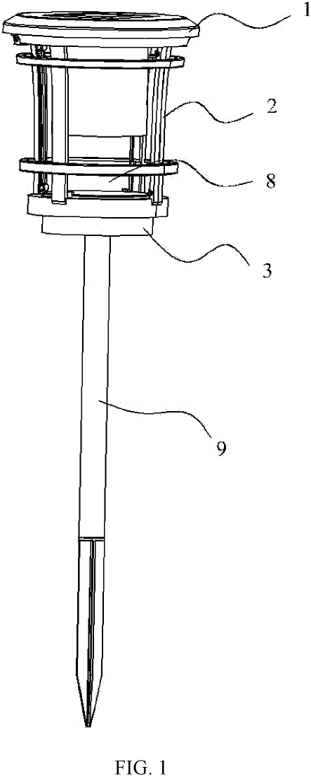

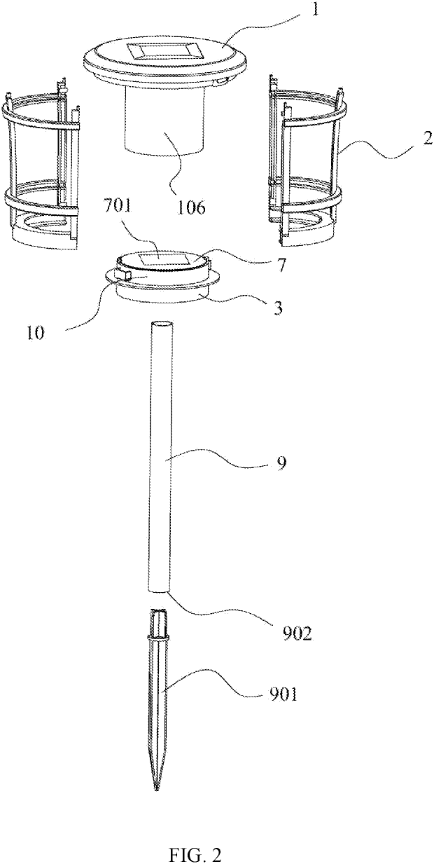

As shown in FIGS. 1-2, the present application discloses an outdoor viscous trap mosquito killing lamp including a lamp body 1, a frame 2 and a base 3. The lamp body 1 is positioned above which the lamp body 1, the frame 2 is connected between the lamp body 1 and the base 3.

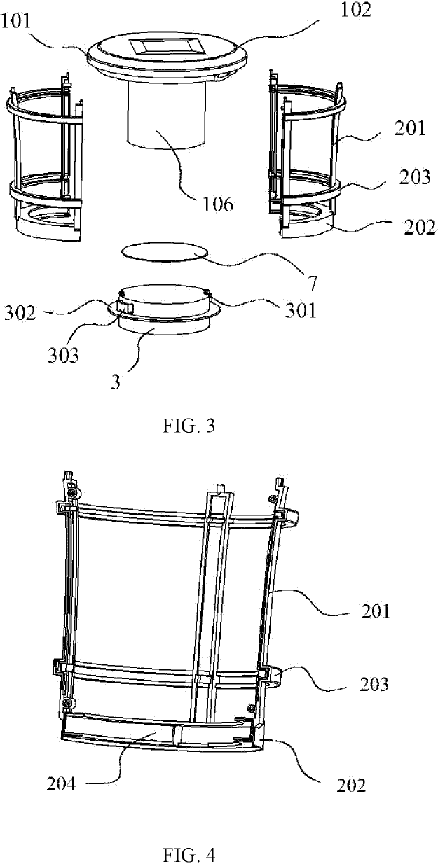

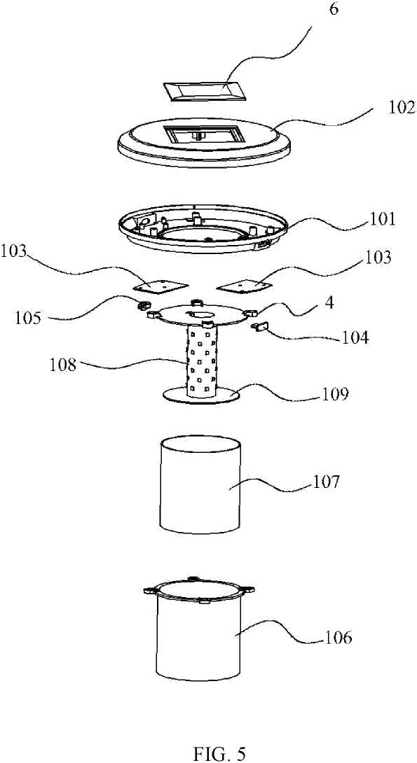

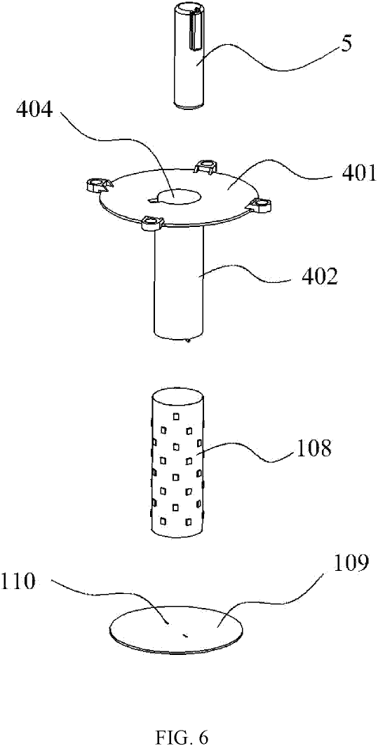

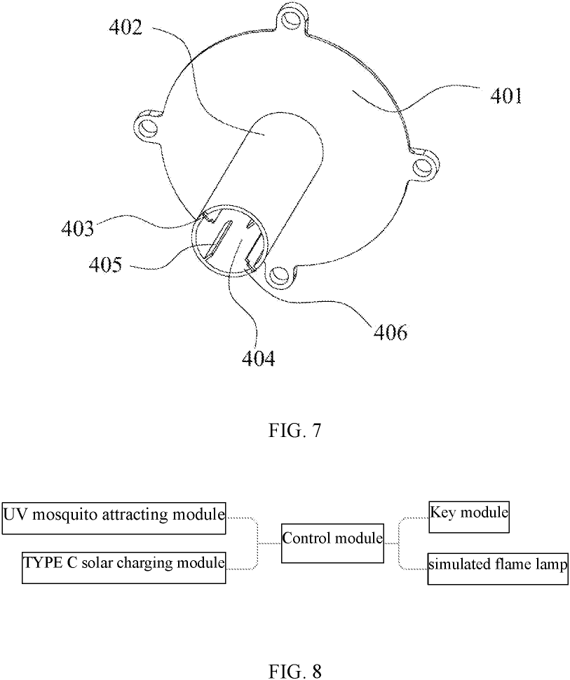

As shown in FIGS. 3-7, the lamp body 1 includes a control box 10 and a light emitting assembly connected to the control box. The control box 10 includes a case body 101 and a case cover 102. An upper end of the case body 101 is provided with an opening, the case cover 102 covers the case body 101 and seals the opening. A housing chamber is formed between the case body 101 and the case cover 102, a control board 103 is fixedly mounted in the housing chamber. A charging interface 104 and a switch 105 are arranged on a sidewall of the case body 101, and are electrically connected to the control board 103.

The light emitting assembly includes a light emitting module, a lamp cover 106 and a cylindrical light cover 107. The light emitting module includes a lighting lamp set 108 and a mosquito attracting lamp set 109. The lighting lamp set 108 includes a lighting board and a number of lighting elements. The lighting board is cylindrical shaped, and the lighting elements are connected to a sidewall of the lighting board. The mosquito attracting lamp set 109 includes a mosquito attracting lamp board which is flat shaped and a plurality of mosquito attracting lights connected to the mosquito attracting lamp board. The cylindrical light cover 107 is semitransparent, and the color of the cylindrical light cover 107 can be selected as desired, such that a color of a light passing through the cylindrical light cover 107 may be changed.

A supporting member 4 is connected to a bottom plate of the control box. The supporting member 4 includes a mounting ring 401 and a hollow supporting column 402. An upper end of the supporting column 402 is connected to the mounting ring 401, an inner cavity of the supporting column 402 is in communication with the inner cavity of the control box. The bottom plate of the case body 101 is provided with a through hole, the supporting columns 402 of the supporting member 4 passes through the through hole and is exposed outside the bottom plate of the case body 101, and the mounting ring 401 are fixedly connected to an inside of the bottom plate of the case body 101. The lighting board fits outside the supporting column 402, the mosquito attracting board is connected to a lower end of the supporting column 402, and the mosquito attracting board covers the opening 406 at the lower end of the supporting column 402 and limits the lighting lamp set 108. The mosquito attracting board is provided with a jack 110, and the lower end of the supporting columns 402 is provided with an insert 403, the insert 403 is inserted into the jack 110, the mosquito attracting lights arranged on the mosquito attracting board face downward.

An upper end of the lamp cover 106 is provided with an opening, the lamp cover 106 covers the lighting lamp set 108 and the mosquito attracting lamp set 109, and the upper end of the lamp cover 106 is fixedly connected to a lower surface of the case body 101. The cylindrical lamp shade 107 is mounted around the lighting lamp set 108 and is arranged within the lamp cover 106. Both of the lighting lamp set 108 and the mosquito attracting lamp set 109 are electrically connected to the control board 103. An inner cavity of the supporting column 402 serves as a battery housing 404, a battery 5 is arranged in the battery housing 404. A limiting post 405 is arranged on an inner wall of the supporting column 402, the limiting post 405 abuts against a lower side of the battery 5 and is used to limit a position of the battery 5. The battery 5 is electrically connected to the control board 103. A solar panel 6 is arranged on an upper surface of the control box 10 and is electrically connected to the control board 103.

The base 3 is arranged below the lamp cover 106 and the frame 2 is connected between the control box 10 and the base 3. A trapping plate 7 is detachably connected to an upper surface of the base 3, the upper surface of the base 3 is provided with at least two slots 301 in which side edges of the trapping plate 7 are plugged. An upper surface of the trapping plate 7 is attached with a viscous sticker 701 which can be torn off after a period of use for replacement. The trapping plate 7 is positioned directly below the lamp cover 106 and an area between the lamp cover 106 and the trapping plate 7 serves as a trapping area 8. The light emitted by the lighting lamp set 108 transmits from a side portion of the viscous trap mosquito killing lamp; the light emitted by the mosquito attracting lamp set 109 transmits towards the trapping plate 7.

The frame 2 is provided with vertical connection rods 201, a connecting ring 202 and a supporting ring 203; at least two connecting rods 201 are provided. In this embodiment, four connecting rods 201 are provided. A lower end of each of the connecting rods 201 is connected to the connecting ring 202, an upper end of each of the connecting rods 201 is connected to the case body 101 of the control box. The supporting ring 203 is positioned an outer side of the connecting rods 201 and is connected to the connecting rods 201. The connecting ring 202 fits over an upper end of the base 3, a limiting protruding ring 302 is provided on a sidewall of the base 3, and a lower end of the frame 2 is fitted over the upper end of the base 3 and a lower end surface of the frame 2 abuts against the limiting protruding ring 302. A protrusion 303 is provided on a sidewall of the upper end of the base 3, and an inner wall of a lower end of the frame 2 is provided with a groove 204, the protrusion 303 is engaged in the groove 204. The lamp cover 106 extends into the frame 2. In this embodiment, the frame 2 is formed by splicing two sub-frames of identical construction, such a configuration is are simple and less expensive to be manufactured, and is easier to be assembled.

A supporting bar 9 is connected to a lower surface of the base 3, a lower end of the supporting bar 9 is provided with a pointed cone 901 and a sleeve 902, an upper end of the pointed cone 901 is inserted in the sleeve 902.

As shown in FIG. 8, a control circuit on the control board includes a control module, a key module, a simulated flame lamp module, a mosquito attracting lamp module, and a solar charging module. Each of the key module, the simulated flame lamp module, the mosquito attracting lamp module, and the solar charging module is electrically connected to the control module. The simulated flame lamp module can cause the lighting lamp set to exhibit the effect of a flame lamp. The key module is used to control the simulated flame lamp module and the mosquito attracting lamp module to turn on or off. Wherein the mosquito attracting lamp module is configured to control operation of the mosquito attracting lamp set, wherein each of the mosquito attracting lights is an ultraviolet lamp. The solar charging module is connected to the solar panel, and the electric energy generated by the solar panel can be used to charge the battery through the solar charging module.

When the outdoor viscous trap mosquito killing lamp disclosed herein is in use, the lighting lamp set 108 and the mosquito attracting lamp set 109 are turned on, and the light from the lighting lamp set 108 passes through sidewalls of the cylindrical light cover 107 and the lamp cover 106 to transmit outside the viscous trap mosquito killing lamp; the light from the mosquito attracting lamp set 109 passes through a bottom of the cylindrical light cover 107 and transmits to the trapping plate 7. The mosquitoes are attracted by the mosquito attracting lights, get into the trapping area 8, and are sticked on the viscous sticker 701 when landing on the trapping plate 7. After a period of use, the viscous sticker 701 can be torn off the trapping plate 7 for replacement.

1. An outdoor viscous trap mosquito killing lamp, comprising a lamp body, wherein the outdoor viscous trap mosquito killing lamp further comprises a frame and a base, the lamp body is positioned above the base, the frame is connected between the lamp body and the base; a light emitting assembly of the lamp body extends into the frame; a trapping plate is arranged on the base and is positioned within the frame, the trapping plate is positioned below the light emitting assembly; an area between the light emitting assembly and the trapping plate serves as a trapping area.

2. The outdoor viscous trap mosquito killing lamp according to claim 1, wherein the trapping plate is detachably connected to an upper surface of the base and a viscous sticker is attached to an upper surface of the trapping plate.

3. The outdoor viscous trap mosquito killing lamp according to claim 1, wherein a limiting protruding ring is provided on a sidewall of the base, a lower end of the frame is mounted around an upper end of the base and a lower end surface of the frame abuts against the limiting protruding ring.

4. The outdoor viscous trap mosquito killing lamp according to claim 3, wherein a protrusion is provided on a sidewall of the upper end of the base, an inner wall of the lower end of the frame is provided with a groove, the protrusion is engaged in the groove.

5. The outdoor viscous trap mosquito killing lamp according to claim 4, wherein the frame is provided with connecting rods, a connecting ring and a supporting ring; an number of the connecting rods is at least two, a lower end of each connecting rod is connected to the connecting ring, an upper end of each connecting rod is connected to the lamp body, and the supporting ring is arranged on an outer side of the connecting rods and connected to the connecting rods; the connecting ring is mounted around the upper end of the base.

6. The outdoor viscous trap mosquito killing lamp according to claim 1, wherein the lamp body further comprises a control box, a control board is arranged within the control box; the light emitting assembly comprises a light emitting module and a lamp cover, the light emitting module is connected to the control box and the lamp cover covers the light emitting module, and the light emitting assembly is electrically connected to the control board.

7. The outdoor viscous trap mosquito killing lamp according to claim 6, wherein a supporting member is connected to a bottom plate of the control box; the light emitting module comprises a lighting lamp set disposed on a sidewall of the supporting member and a mosquito attracting lamp set disposed on a lower end of the supporting member; light emitted by the lighting lamp set transmits from a side portion of the outdoor viscous trap mosquito killing lamp; and light emitted by the mosquito attracting lamp set transmits to the trapping plate.

8. The outdoor viscous trap mosquito killing lamp according to claim 7, wherein the supporting member comprises a mounting ring and a hollow supporting column, an upper end of the supporting column is connected to the mounting ring, the mounting ring is fixedly connected to the bottom plate of the control box, an inner cavity of the supporting column is in communication with an inner cavity of the control box; the lighting lamp set is sleeve-shaped and is disposed around the supporting column; the mosquito attracting lamp set is flat-shaped and is connected to a lower end of the supporting column, and the mosquito attracting lamp set covers an opening at the lower end of the supporting column and limits the lighting lamp set.

9. The outdoor viscous trap mosquito killing lamp according to claim 8, a cylindrical light cover surrounds the lighting lamp set and is semitransparent, the cylindrical light cover is arranged within the lamp cover.

10. The outdoor viscous trap mosquito killing lamp according to claim 8, an inner cavity of the supporting column serves as a battery housing, a battery is arranged within the battery housing; a limiting post is arranged on an inner wall of the supporting column, the limiting post abuts against a lower side of the battery, the limiting post limits a position of the battery; the battery is electrically connected to the control board.

11. The outdoor viscous trap mosquito killing lamp according to claim 6, a solar panel is arranged on an upper surface of the control box, the solar panel is electrically connected to the control board.

12. The outdoor viscous trap mosquito killing lamp according to claim 1, wherein a supporting bar is connected to the base and a lower end of the supporting bar is provided with a pointed cone.
